(19) United States
(12) Patent Application Publication
(10) Pub. No.: US 2014/0287088 A1
(43) Pub. Date: Sep. 25, 2014

(54) Calcium Citrate-Malate as source of calcium to prevent bone diseases and increase bone strength in young animals and birds, especially young poultry, dogs, cats, swine, calves, and horses; and laying hens

(71) Applicant: Michael Herbert Henry, Germantown, MD (US)

(72) Inventor: Michael Herbert Henry, Germantown, MD (US)

(21) Appl. No.: 13/848,051

(22) Filed: Mar. 20, 2013

(51) Int. Cl. A23K 1/175

(52) U.S. Cl. CPC A23K 1/1753
USPC 426/2

(57) ABSTRACT

This invention relates to addition of calcium citrate-malate in the feed of young animals and poultry. Growth in young animals and poultry is rapid. During the early stages of development, a highly soluble and bioavailable source of calcium is needed for healthy growth and bone development. In addition, this invention also relates to a source of calcium in the feed of laying hens. Laying hens require large quantity of calcium for eggshell formation. While the hens can mobilize calcium from bone to supplement the dietary calcium, the mobilization is slow and inefficient. The mobilization of bone calcium is also detrimental to health of hens. Laying hens often have bone defects and inferior eggshell. The addition of calcium citrate-malate to feeds and milk replacers of young animals enhances the bioavailability calcium for growth and bone development and improves health and eggshell quality of laying hens.

### CROSS REFERENCE TO RELATED APPLICATIONS

This application claims the benefit of and priority to provisional application 61/605,178

### TECHNICAL FIELD

1. Abstract

The present invention relates to improvement of the health and development of bone in young animals and poultry. In addition, this invention enhances the eggshell quality of birds. The addition of calcium citrate malate to feed of animals enhanced the bioavailability calcium for development.

2. Background Art

Reports have shown that calcium citrate-malate (CC-M), a compound used to fortify food with calcium for human consumption, is 10 times more soluble than calcium citrate, which is more soluble than calcium carbonate (Andon et al., 1996; Heaney et al., 1990; Smith t al., 1987). Results from studies with humans also demonstrate that calcium absorption and retention from CCM-fortified food is significantly greater than food fortified with calcium carbonate (Andon et al., 1996; Miller et al., 1988). In animal studies, trabecular bone was significantly affected by calcium source and level (Kochanowski, 1990). Rats fed CC-M had 23 to 25% more trabecular bone than those rats fed calcium carbonate at 4 wk, and by 12 wk the difference increased to 44%. Based on these results, it is concluded that calcium in CC-M is more bioavailable than calcium from calcium carbonate. Because of these differences in mammalian species, we propose the use of evaluate CC-M as a source of calcium in the feed for of young animals, especially broiler chickens, piglets, calves, turkeys, fowl diets, and pets.

In growing young animals, the availability of calcium from most calcium sources is not readily bioavailability. For example, in young chicken, is a major skeletal problem and is associated with calcium and phosphorus deficiency and imbalance. The tibial dyschondroplasia lesion is characterized by amass of white, opaque, unmineralized, unvascularized cartilage and is found predominantly in the proximal metaphysis of the tibiotarsus. The lesion is a result of the failure of the prehypertropic cartilage cells to undergo normal maturation and vascularization (Riddell, 1975; Poulos et al., 1978; McCaskey et al., 1982). Birds afflicted with severe cases of tibial dyschondroplasia generally have bowed legs. They sit on their hocks and are reluctant to move. Birds with tibial dyschondroplasia spend a significant portion of their time on their breasts, resulting in a higher incidence of breast blisters. In most instances, only a very small percentage of the birds affected by tibial dyschondroplasia show clinical symptoms. Both clinical and subclinical cases can result in economic loss due to trimming and down-grading of carcasses (Burton et al., 1981).

Studies have shown that the expression of bone disease in young animals was influenced by genetics (Leach and Nesheim, 1965; Riddell, 1976; Sheridan et al., 1978). These researchers were able to produce, by genetic selection, lines of chickens with high (80%) and low (2%) incidence of tibial dyschondroplasia. These lines were used to study the relationship between calcium and phosphorus and this disease. It was also shown that male chicks were more susceptible to the development of tibial dyschondroplasia (Riddell, 1976; Edwards, 1984).

In a study by Leach and Nesheim (1965), it was concluded that calcium and phosphorus had no influence on the etiology of tibial dyschondroplasia. However, Edwards and Veltmann (1983) reported that tibial dyschondroplasia could be induced by diets with a low calcium:phoshorus ratio regardless of the calcium levels. Chicks fed diets of 1.1% calcium and total phosphorus of 0.53% did not exhibit tibial dyschondroplasia, but a 37% incidence was found in birds fed 0.70% calcium and 1.01% phosphorus.

These results were later confirmed in studies by several researchers (Lilburn et al., 1983; Edwards, 1984; Hulan et al., 1985; Kling, 1985; Riddell and Pass, 1987; Lilburn et al., 1989) and clearly demonstrate that calcium is important in the prevention of tibial dyschondroplasia. However, the availability of dietary calcium to chicks for proper bone development and prevention of tibial dyschondroplasia are affected by several factors including age, strain, calcium source, 1, 25-dihydroxycholecalciferol level in the gut, and ultraviolet irradiation (Edwards 1992; Cook et al., 1994; Leach and Twal, 1994; Lilburn, 1994).

Additionally, eggs of poultry, such as fowl, are often broken when laid, or during handling steps including egg collection, selection, washing, packaging, transportation, display, selling, storage, and the like. The strength of poultry eggs relates to the eggshell structure and correlates to the thickness and specific gravity of the eggshell. The eggshell structure is composed of the eggshell, the eggshell membrane and the cuticle. A fowl eggshell weighs about 5 g on average, has a thickness of from 300 to 360 microns and is composed of about 98% inorganic matter (98.4% calcium carbonate with magnesium carbonate and calcium phosphate each in a trace amount) and about 2% organic matter, by weight. A fowl eggshell membrane has a thickness of about 70 microns and consists of the external eggshell membrane and the internal eggshell membrane. At the obtuse end of the egg, the external eggshell membrane and the internal eggshell membrane split forming the air chamber. The eggshell membrane is composed of about 90% proteins, about 3% lipids and about 2% saccharides, by weight. A fowl egg cuticle is a shapeless coating formed on the surface of the eggshell immediately after egg-laying, from the drying of gelatinous material secreted at egg laying. It is composed of about 85% to 87% proteins, about 3.5% to 3.7% saccharides and about 2.5% to 3.5% lipids, by weight. The eggshell thickness varies depending on temperature and age. Namely, eggshell thickness becomes thinner at higher temperatures or as aging proceeds.

Since calcium is the major component of eggshell, the blood calcium level would relate to the formation of eggshell. Calcium absorbed from the intestinal tract is first accumulated in the femora and then liberated, when necessary, into the blood in the form of osteoblasts, thus participating in the eggshell formation. Therefore, poultry eggshells can be thickened by promoting the absorption and metabolism of calcium. Although the role of the eggshell membrane is not known in detail, it is assumed that the eggshell can be strengthened as the eggshell membrane is thickened together with the eggshell.

### SUMMARY OF INVENTION

### Technical Problem

In growing young animals, the availability of calcium from most calcium sources is not readily bioavailability. For example, in young chicken, is a major skeletal problem and is associated with calcium and phosphorus deficiency and imbalance. The tibial dyschondroplasia lesion is characterized by amass of white, opaque, unmineralized, unvascularized cartilage and is found predominantly in the proximal metaphysis of the tibiotarsus. The lesion is a result of the failure of the prehypertropic cartilage cells to undergo normal maturation and vascularization (Riddell, 1975; Poulos et al., 1978; McCaskey et al., 1982). Birds afflicted with severe cases of tibial dyschondroplasia generally have bowed legs. They sit on their hocks and are reluctant to move. Birds with tibial dyschondroplasia spend a significant portion of their time on their breasts, resulting in a higher incidence of breast blisters. In most instances, only a very small percentage of the birds affected by tibial dyschondroplasia show clinical symptoms. Both clinical and subclinical cases can result in economic loss due to trimming and down-grading of carcasses (Burton et al., 1981).

Studies have shown that the expression of bone disease in young animals was influenced by genetics (Leach and Nesheim, 1965; Riddell, 1976; Sheridan et al., 1978). These researchers were able to produce, by genetic selection, lines of chickens with high (80%) and low (2%) incidence of tibial dyschondroplasia. These lines were used to study the relationship between calcium and phosphorus and this disease. It was also shown that male chicks were more susceptible to the development of tibial dyschondroplasia (Riddell, 1976; Edwards, 1984).

In a study by Leach and Nesheim (1965), it was concluded that calcium and phosphorus had no influence on the etiology of tibial dyschondroplasia. However, Edwards and Veltmann (1983) reported that tibial dyschondroplasia could be induced by diets with a low calcium:phoshorus ratio regardless of the calcium levels. Chicks fed diets of 1.1% calcium and total phosphorus of 0.53% did not exhibit tibial dyschondroplasia, but a 37% incidence was found in birds fed 0.70% calcium and 1.01% phosphorus.

In laying hens, each egg shell contains up to 3 grams of calcium. Therefore, the diet of hens must contain adequate calcium in a form that can be utilized efficiently. There is conflicting evidence about the use of particulate calcium although the consensus appears to be that 50 to 70% of the calcium should be in the form of coarse 2 to 5 mm diameter) particles and the remainder in powder form (Nys, 1999). The provision of larger particles (e.g. shell grit) has been shown to have beneficial effects but is not always compatible with automated feeding systems. Some authors recommend a mixture of ground limestone and oyster shell (Richter et al., 1999). Inadequate dietary phosphorus may cause demineralisation of the skeleton in the laying hen. The ratio of calcium to phosphorus in the diet is important as high levels of phosphorus may interfere with the absorption of calcium from the gut, resulting in reduced shell quality. The available calcium and phosphorus requirements appear to be influenced by the age of the birds, amongst other things. In addition, environmental considerations have resulted in pressure to minimize levels of phosphorus in the diets, especially in some densely populated countries.

The levels of available calcium in feed need to be increased during the rearing period, 1 to 5 days prior to the appearance of the first egg (Roland and Bryant, 1994.). There is some evidence that provision of additional calcium too soon can result in negative effects on the kidneys if the levels of phosphorus are low. However, more importantly, if available calcium is not provided early enough, there may be long-term negative effects on calcium metabolism and bone stores of calcium (Nys, 1999; Roland and Bryant, 1994).

### Solution to Problem

The object of the present invention is to provide a highly available source of calcium for the early bone formation in young animals, to improve growth, to increase feed utilization, to improve bone composition, prevent the early onset of bone disease in young animals such as tibial dyschondroplasia in young broiler chicks, and to provide a poultry eggshell strengthening compound capable of enhancing eggshell thickness when added to feed, and the like.

In the present invention, calcium citrate-malate manufactured from calcium hydroxide, calcium carbonate, or calcium oxide and citric and malic acid and water is added to the feed intended for young animals to provide between 10% and 75% of the calcium required in the diet. In the early stages of life, from birth or hatching to sexual maturity, bone growth is at the most rapid stages and the demand for calcium requires that animals are fed a highly bioavailable source and an adequate level in the diet. Typically, diets for young animals have calcium levels between 0.6% to 1.5%, of which the majority is from calcium carbonate or limestone.

Symptoms of calcium deficient, such as retarded growth, decreased feed consumption, high metabolic rate, reduce activity, calcium rickets, abnormal posture, thin eggshell, and reduce egg production, are occasionally observed when calcium carbonate or limestone is added to the diet to provide adequate level of calcium. The addition of the highly bioavailable calcium citrate-malate to supply between 10% and 75% of the calcium required in the diet instead of calcium carbonate would prevent the onset of bone disease and enhance eggshell quality.

In addition, the poultry industry continues to experience economic losses due to breakage and cracked eggshells although the feed contain adequate level of calcium supplied by limestone and oyster shell. The losses run into millions of dollars each year while producers are using all the genetics and nutritional aids to reduce the losses. We have examined the use of calcium citrate malate as a source of calcium in laying hens and theorize that the use of calcium citrate malate as a source of calcium in the feed would significantly reduce the number of broken and cracked eggs. Because calcium citrate malate is highly soluble, it would provide the hens with a large pool of calcium for the formation of the eggshell as it digest and absorb the calcium from limestone and spare the calcium reabsorbed from the bird bones. Typically, diets for laying hens have calcium levels between 3% to 3.7% calcium, the majority is from calcium carbonate or limestone. In this invention, calcium citrate malate would be used to provide up to 50% of the calcium required in the diet of laying hens or calcium citrate malate is added to provide up to 1.8% calcium in the diet laying hens.

The birds whose eggshell thickness are to be enhanced according to the present invention are not particularly restricted. Examples thereof include fowl (chicken), turkey, duck, bantam, goose and quail.

### Advantageous Effects of Invention

The use of calcium citrate malate in the diet prevent the symptoms of calcium deficient, such as retarded growth, decreased feed consumption, high metabolic rate, reduce activity, calcium rickets, abnormal posture, thin eggshell, and reduce egg production that are observed when calcium carbonate or limestone is added to the diet to provide adequate level of calcium

### BRIEF DESCRIPTION OF DRAWINGS

None

### DESCRIPTION OF EMBODIMENTS

Embodiments of the present invention may generally relate to the use of calcium citrate malate in the feed of young animals, including milk replacers, and the feed of laying hens.

### A. Definitions

As used herein, the term “calcium citrate malate” refers to calcium compound consisting of citrate and malate units, in liquid or dried form.

As used herein, the term “calcium citrate malate” may be used interchangeably with the term “CCM”

As used herein, the term “young animal” may be used interchangeably with “chicks, poults, calves, lambs, kids, piglets, pups, foal, and kittens.”

As used herein, the term “ingredients” means various components used in the manufacture of feed.

### B. Process

Exemplary embodiment of this invention may generally comprise feed for young animals and poultry, and laying hens containing calcium citrate malate to supply up to 50% of the calcium in the feed. Using least cost formulation with calcium citrate malate at a fixed percentage in the feed (example, 0.25%, 0.4%, 0.5%, etc.), feed for young animals are formulated and manufactured for the intended animals.

### EXAMPLES

The following illustrates the preparation of feed for young animals and poultry and feed for laying hens, but is not intended to be limiting thereof.

### Example I

When calcium citrate malate was used as source of calcium in diet of young chickens.

Young chicks are fed diet formulated to contain 0.9% calcium by adding 10.5g of calcium citrate malate per kg of feed formulated with corn and soybean meal. Dicalcium phosphate was the supplemental phosphorus source and to provided 34.5% of the dietary calcium in the diets. Example of diet formulation: Ground yellow corn: 52.27(%); Soybean meal (dehulled): 37.71(%); Poultry fat: 6.366(%); Iodized NaCl: 0.400(%); Dicalcium phosphate (feed grade): 1.643(%); Limestone: 0.25(%); Calcium citrate-malate: 1.05(%); Vitamin mixture: 0.25(%); DL-Methionine 0.19(%); Mineral mixture 0.075(%).

### Example II

When calcium citrate malate was used as source of calcium in diet of laying hens.

Laying hens are fed diet formulated to contain 3.75% calcium by adding 10 g of calcium citrate malate per kg of feed formulated with corn and soybean meal. Limestone and dicalcium phosphate was the main calcium and phosphorus source in the diets. Example of diet formulation: Corn, 67.23%; Soybean meal, 20.79%; Limestone, 7.29%; Dicalcium phosphate, 1.9%; Calcium citrate malate, 1.0%; Alfalfa meal, 1.00%; Salt (NaCl ),0.37%; Vitamin premix, 0.25%; Mineral premix, 0.25%; DL-methionine, 0.1%; Sand, 0.11%.

### Example III

When calcium citrate malate was used as source of calcium in milk replacer for young pigs.

In response to separation at young age requires piglets receive a specialized diet that allows them to achieve acceptable weight gain and bone development after weaning. Piglets are fed diet formulated to contain 1% calcium by adding 10 g of calcium citrate malate per kg of feed formulated with corn and soybean meal. Limestone and dicalcium phosphate was the main calcium and phosphorus source in the diets. Composition of 1 gallon of liquid diets for piglets: Water 3487 g; Fat 325 g, Sweet dairy whey 225, Calcium caseinate 301 g; Citric acid (monohydrate) 4.8; Choline chloride 1 g Lecithin 1.1 g, Vitamin premix 7.9 g, Mineral premix 47.1, Calcium citrate malate, 5 g.

### INDUSTRIAL APPLICABILITY

Use in manufacture of feed for livestock and poultry production system.

### CITATION LIST

### Patent Literature

| | | |
|---|---|---|
| 4,551,342 | November 1985 | Nakel et al. |
| 4,722,847 | February 1988 | Heckert |
| 4,737,375 | April 1988 | Nakel et al. |
| 4,786,510 | July 1988 | Nakel |
| 4,786,518 | November 1988 | Nakel |
| 4,830,862 | May 1989 | Braun et al. |
| 4,992,282 | February 1991 | Mehansho |
| 4,994,283 | February 1991 | Mehansho |
| 5,186,965 | February 1993 | Fox, et al. |
| 7,504,536 | March 2009 | Luhadiya, et al. |

### Non Patent Literature

1. Andon, M. A., M. Peacock, R. L. Kanerva, and J. A. S. De Castro. 1996. Calcium absorption from apple and orange juice fortified with calcium citrate-malate (CCM). J. Am. Col. Nutr. 15:313-316.
2. AOAC. 1990. Official Methods of Analysis. 15th ed. Association of Official Analytical Chemists, Arlington, Va.
3. Buchnowski, M. S., and D. D. Miller. 1991. Lactose, calcium source and age affect calcium bioavailability in rats. J. Nutr. 121:1746-1754.
4. Burton, R. W., A. K. Sheridan, and C. R. Howlett. 1981. The incidence and importance of tibial dyschondroplasia to commercial broiler industry in Australia. Br. Poult. Sci. 222:153-160.
5. Cook, M. E., Y. Bai, and M. W. Orth. 1994. Factors influencing growth plate cartilage turnover. Poult. Sci. 73:889-896.
6. Edwards, H. M., Jr., and J. R. Veltmann. 1983. The role of calcium and phosphorus in the etiology of tibial dyschondroplasia in young chickens. J. Nutr. 113:1568-1575.
7. Edwards, H. M., Jr. 1984. Studies on the etiology of tibial dyschondroplasia in chickens. J. Nutr. 114:1001-1013.
8. Edwards, H. M., Jr. 1992. Nutritional factors and leg disorders. Pages 167-193 in Bone Biology and Skeletal Disorders in Poultry. C. C. Whitehead, ed. Carfax Publishing Co., Abingdon, UK.
9. Etheridge, R. D., G. M. Pesti, and E. H. Foster. 1998. A comparison of nitrogen values obtained utilizing the Kjeldahl nitrogen and Dumas combustion methodologies (Leco CNS 2000) on samples typical of an animal nutrition analytical laboratory. Anim. Feed Sci. Technol. 73:21-28.
10. Heaney, R. P. 1988. Nutritional factors in bone health. Pages 297-312 in Osteoporosis: Etiology, Diagnosis, and Management. B. L. Riggs and L. J. Melton, ed. Raven Press, New York.
11. Heaney, R. P., R. R. Recker, and C. M. Weaver. 1990. Absorbability of calcium sources: The limited role of solubility. Calcif. Tissue Int. 46:300-304.
12. Hill, J. B. 1955. Automated fluorometricmethod for determination of serum calcium. Clin. Chem. 2:122-130.
13. Hulan, H. W., G. Degroote, G. Fontaine, and G. Demunter. 1985. The effect of different totals and ratios of calcium and phosphorus on the performance and incidence of leg abnormalities of male and female broiler chickens. Poult. Sci. 64:1157-1169.
14. Kling, L. T. 1985. The effects of calcium and phosphorus on the incidence of tibial dyschondroplasia in young chicks. Nutr. Rep. Int. 32:1473-1480.
15. Kochanowski, B. A. 1990. Effect of calcium citrate-malate on skeletal development in young, growing rats. J. Nutr. 120:876-881.
16. Leach, R. M., and M. C. Nesheim. 1965. Nutritional, genetic and morphological studies of an abnormal cartilage formation in young chicks. J. Nutr. 86:236-244.
17. Leach, R. M., and W. 0. Twal. 1994. Autocrine, paracrine, and hormonal signals involved in growth plate chondrocyte differentiation. Poult. Sci. 73:883-888.
18. Lilburn, M. S. 1994. Skeletal growth of commercial poultry species. Poult. Sci. 73:897-903.
19. Lilburn, M. S., T. J. Lauterio, K. N. Rilling, and J. H. Smith. 1989. The relationships among mineral balance in the diet, early growth manipulation, and incidence of tibial dyschondroplasia in different strains of meat type chickens. Poult. Sci. 68:1263-1273.
20. McCaskey, P. C., G. N. Rowland, R. K. Page, and L. R. Minear.1982. Focal failure of endochondral ossification in the broiler. Avian Dis. 26:701-717.
21. Miller, J. Z., D. L. Smith, L. Flora, C. Slemenda, X. Jiang, and C. C. Johnson, Jr. 1988. Calcium absorption from calcium carbonate and a new form of calcium (CCM) in healthy male and female adolescents. Am. J. Clin. Nutr. 48:1291-1294.
22. Riddell, C. 1975. The development of tibial dyschondroplasia in broiler chickens. Avian Dis. 19:443-462.
23. Sheridan, A. K., C. R. Howlett, and R. W. Burton. 1978. The inheritance of tibial dyschondroplasia in broilers. Br. Poult. Sci. 19:491-499.
24. Smith, K. T., R. P. Heaney, L. Flora, and S. M. Hinders. 1987. Calcium absorption form a new calcium delivery system. Calcif. Tissue 41:351-352.
25. Weaver, C. M. 1992. Calcium bioavailability and its relation to osteoporosis. Proc. Soc. Exp. Biol. Med. 200:157-160.

We claim:

1. A method of feeding young poultry chicken, turkey, geese, ducks, quails) and young animals (swine, cattle, sheep, goats, dogs, cats, not excluding other species) feed comprising of primarily corn, wheat, or barley, and soybean meal as a diet, wherein said diet contains calcium citrate malate to provide up to 50% of the dietary calcium to improve growth, to enhance bone development, and to prevent tibial dyschondroplasia.

2. A method of feeding young pigs a feed comprising of corn soybean meal as in a piglet diet, wherein said piglet diet contains calcium citrate malate to provide up to 50% of the dietary calcium, to enhance bone development, to prevent bone malformation and improve growth.

3. A method of feeding young animals (swine, cattle, sheep, goats, dogs, cats, not excluding other species) liquid feed (milk replacer) comprising of whey protein and vegetable oil as a milk replacer, wherein said milk replacer contains calcium citrate malate to provide up to 50% of the dietary calcium, to enhance bone development, to prevent bone malformation and improve growth.

4. A method of feeding calves, kids, lambs a feed comprising of corn soybean meal as in a diet, wherein said the diet contains calcium citrate malate to provide up to 50% of the dietary calcium, to enhance bone development, to prevent bone malformation and improve growth.

5. A method of feeding calves, kids, lambs liquid feed comprising of whey protein and vegetable oil as a milk replacer, wherein said milk replacer contains calcium citrate malate to provide up to 50% of the dietary calcium, to enhance bone development, to prevent bone malformation and improve growth

6. A method of feeding pups and kittens a diet, wherein said the diet contains calcium citrate malate to provide up to 50% of the dietary calcium, to enhance bone development, to prevent bone malformation and improve growth.

7. A method of feeding laying hens a diet, wherein said the diet contains calcium citrate malate to provide up to 30% of the dietary calcium, to enhance eggshell thickness and to prevent bone loss in hens.
